(19) United States
(12) Patent Application Publication
(10) Pub. No.: US 2012/0261221 A1
(43) Pub. Date: Oct. 18, 2012

(54) PROCESS FOR PRODUCING AN ENERGY-ABSORBING COMPONENT

(75) Inventors: Andreas Wuest, Zwingenberg (DE); Marco Gross, Bad Duerkheim (DE); Helge Weiler, Edingen-Neckarhausen (DE)

(73) Assignee: BASF SE, Ludwigshafen (DE)

(21) Appl. No.: 13/443,294

(22) Filed: Apr. 10, 2012

Related U.S. Application Data
(60) Provisional application No. 61/475,675, filed on Apr. 15, 2011.

(51) Int. Cl. B29C 45/00; F16F 7/12

(52) U.S. Cl. 188/377; 264/328.1

(57) ABSTRACT

The invention relates to a process for producing an energy-absorbing component composed of profile elements, made of a polymer material, which are open on one side, respectively orientated in opposite directions, and connected to one another on at least one side as a single piece to give a linearly continuous structure. The process involves (a) closure of a mold comprising at least two mold-section profiles, which can be moved in opposite directions and respectively have protruding regions and recessed regions such that, in a closed condition, the protruding regions of oppositely arranged profiles intermesh; (b) injection of the polymer material into a mold; and (c) opening of the mold, by moving the mold-section profiles apart in an opposite direction, and removing the energy-absorbing component.

The invention relates to a process for producing an energy-absorbing component composed of profile elements made of a polymer material which are open on one side and have been respectively orientated in opposite direction, and have been connected to one another at at least one side in the manner of a single piece to give a linearly continuous structure.

Energy-absorbing components are used by way of example in the automobile industry in the bumper sector. Energy is absorbed via deformation and controlled failure of the components, for example in a collision. Since weight reduction is essential if a desired reduction in fuel consumption is to be achieved, it is desirable to manufacture the components from less heavy materials, for example from plastics. Another essential factor, in particular for energy-absorbing components, such as those used in the bumper sector, is that the components have the best possible failure behavior. The aim is to obtain higher energy absorption while minimizing overall size.

Bumpers currently in particular use polymer foams as energy-absorbing material. However, polymer foams exhibit deformation behavior in which, when the force applied remains constant, a large amount of deformation initially occurs, reducing as deformation of the foam increases. This type of failure behavior is undesirable when the aim is to minimize the load experienced not only by the object colliding with the vehicle but also by the vehicle bodywork itself.

Another known method, alongside the use of foams, uses non-foamable polymers for manufacturing the energy-absorbing components used as motor vehicle bumpers. This is disclosed by way of example in WO-A 02/087925. The energy-absorbing component comprises a structure with a B-shaped profile on which there are individual protector elements applied. Exposure to a force produces initially deformation and then failure via fracture. The energy-absorbing component is produced by way of example via an injection-molding process.

WO-A 03/104030 also discloses a bumper which comprises an energy-absorbing component made of a polymer material. The bumper comprises projecting and recessed sections and has been designed so that, here again, exposure to a force produces initially deformation and then failure via fracture.

A disadvantage of the bumpers known from the prior art is that there are only restricted possibilities for appropriate modification to give the ideal force-displacement curve. By way of example, therefore, the production processes known in the prior art cannot manufacture any energy-absorbing components which by way of example by virtue of their shape have regions which are elastic and uniformly deformable prior to failure of the component. The energy-absorbing components currently produced from foams moreover do not permit variation of the force-displacement curve across the width of the component.

It is an object of the present invention to provide a process which can produce energy-absorbing components and which permits manufacture of components which can be appropriately modified with good results to give an ideal force-displacement curve.

The object is achieved via a process for producing an energy-absorbing component composed of profile elements made of a polymer material which are open on one side and have been respectively orientated in opposite direction, and have been connected to one another at at least one side in the manner of a single piece to give a linearly continuous structure, comprising the following steps:

(a) closure of a mold comprising at least two mold-section profiles which can be moved in an opposite direction and respectively have, in alternating fashion, protruding regions in the form of negative image of the internal side of a profile element and recessed regions in the form of negative image of the external side of an adjacent profile element, where, in the closed condition, the protruding regions of the oppositely arranged mold-section profiles intermesh,

(b) injection of the polymer material into a mold,

(c) opening of the mold, by moving the mold-section profiles apart in an opposite direction, and removal of the component.

The process of the invention permits appropriate modification of the component to give an ideal force-displacement curve, via appropriate modification of the design of the individual profile elements. The process moreover permits, by virtue of the profile elements respectively arranged in opposite direction, production of a component which can give uniform energy adsorption. The energy adsorption results from the controlled force-displacement curve exhibited by the component.

The process of the invention also permits production of components with a shape where undercuts also occur in the direction of load; this is a difference from the processes known from the prior art, where the energy-absorbing components are conical in order to permit demolding of the components, with the resultant disadvantage of only restricted possibilities for shape variation, for example through undercuts occurring in the direction of load, resulting in non-ideal design. The possibilities for appropriate modification to give the desired force-displacement characteristic are thus greater than when the component structures known from the prior art are used.

By virtue of the profile elements which are open on one side and respectively oriented in opposite direction, it is possible to produce a structure of which the overall orientation is in the direction in which the force is applied. By virtue of the alternating direction of opening of the individual profile elements, the structures, which can be subjected to appropriate modification within wide limits, can be demolded without difficulty via use of the two respective mold profiles with protruding and recessed regions, where these intermesh. By varying and combining the respective profile elements, open on one side and oriented in an opposite direction, it is possible to achieve ideal appropriate modification of the energy-absorbing component to meet the different requirements placed upon the force-displacement characteristic across the transverse axis of the vehicle.

The connection of the individual profile elements of at least one side to give a linearly continuous structure results in distribution of the effect of the energy-absorbing component transversely. This ensures that, even if individual profile elements are irreparably damaged, and even if a second impact occurs on the energy-absorbing component, an adequate residual effect can be achieved.

If the profile elements are also connected to one another at a second side in the manner of a single piece to give a linearly continuous structure, the energy-absorbing component can also be appropriately modified in an ideal manner to curved or hollow geometries. Another possibility, for appropriate modification of the force-displacement curve, is to vary the width or thickness of the linearly continuous structure, or to reinforce the same by applying ribs.

The polymer material from which the energy-absorbing component is produced preferably comprises a thermoplastic polymer or an injection-moldable thermoset polymer. The polymer can be used in reinforced or unreinforced form, but it is preferable to use reinforced polymers.

Examples of suitable polymers are natural and synthetic polymers, or derivatives of these, natural resins, and also synthetic resins, and derivatives of these, proteins, cellulose-derivatives, and the like. These can be—but do not have to be—materials which cure chemically or physically, for example being air-curing, radiation-curing, or heat-curing materials.

It is possible to use not only homopolymers but also copolymers or polymer mixtures.

Preferred polymers are ABS (acrylonitrile-butadiene-styrene); ASA (acrylonitrile-styrene-acrylate); acrylated acrylates; alkyd resins; alkylene-vinyl acetates; alkylene-vinyl acetate copolymers, in particular methylene-vinyl acetate, ethylene-vinyl acetate, butylene-vinyl acetate; alkylene-vinyl chloride copolymers; amino resins; aldehyde resins and ketone resins; cellulose and cellulose derivatives, in particular hydroxyalkylcellulose, cellulose esters, such as cellulose acetates, cellulose propionates, cellulose butyrates, carboxyalkylcelluloses, cellulose nitrates; epoxy acrylates; epoxy resins; modified epoxy resins, e.g. bifunctional or polyfunctional bisphenol A or bisphenol F resins, epoxy-novolak resins, brominated epoxy resins, cycloaliphatic epoxy resins; aliphatic epoxy resins, glycidic ethers, vinyl ethers, ethylene-acrylic acid copolymers; hydrocarbon resins; MABS (transparent ABS comprising acrylate units); melamine resins; maleic anhydride copolymers; (meth)acrylates; natural resins; rosins; shellac; phenolic resins; polyesters; polyester resins, such as phenyl ester resins; polysulfones (PSU); polyether sulfones (PESU); polyphenylene sulfone (PPSU); polyamides; polyimides; polyanilines; polypyrroles; polybutylene terephthalate (PBT); polycarbonates (e.g. Makrolon® from Bayer AG); polyester acrylates; polyether acrylates; polyethylene; polyethylenethiophenes; polyethylene naphthalates; polyethylene terephthalate (PET); polyethylene terephthalate glycol (PETG); polypropylene; polymethyl methacrylate (PMMA); polyphenylene oxide (PPO); polyoxymethylene (POM); polystyrenes (PS), polytetrafluoroethylene (PTFE); polytetrahydrofuran; polyethers (e.g. polyethylene glycol, polypropylene glycol); polyvinyl compounds, in particular polyvinyl chloride (PVC), PVC copolymers, PVdC, polyvinyl acetate, and copolymers of these, and optionally partially hydrolyzed polyvinyl alcohol, polyvinyl acetals, polyvinyl acetates, polyvinylpyrrolidone, polyvinyl ethers, polyvinyl acrylates and polyvinyl methacrylates, in solution and in the form of dispersion, and copolymers of these, polyacrylates and polystyrene copolymers; polystyrene (impact-resistant or non-impact-resistant); polyurethanes, non-crosslinked or crosslinked with isocyanates; polyurethane acrylates; styrene-acrylonitrile (SAN), styrene-acrylic copolymers; styrene-butadiene block copolymers (e.g. Styroflex® or Styrolux® from BASF SE, K-Resin™ from TPC); proteins, e.g. casein; SIS; triazine resin, bismaleimide-triazine resin (BT), cyanate ester resin (CE), allylated polyphenylene ether (APPE). Mixtures of two or more polymers can also be used.

Polymers particularly preferred are acrylates, acrylate resins, cellulose derivatives, methacrylates, methacrylate resins, melamine and amino resins, polyalkylenes, polyimides, epoxy resins, modified epoxy resins, e.g. bifunctional or polyfunctional bisphenol A resins or bifunctional or polyfunctional bisphenol F resins, epoxy-novolac resins, brominated epoxy resins, cycloaliphatic epoxy resins, aliphatic epoxy resins, glycidic ethers, cyanate esters, vinyl ethers, phenolic resins, polyimides, melamine resins and amino resins, polyurethanes, polyesters, polyvinyl acetals, polyvinyl acetates, polystyrenes, polystyrene copolymers, polystyrene-acrylates, styrene-butadiene block copolymers, styrene-acrylonitrile copolymers, acrylonitrile-butadiene-styrene, acrylonitrile-styrene-acrylate, polyoxymethylene, polysulfones, polyether sulfones, polyphenylene sulfone, polybutylene terephthalate, polycarbonates, alkylene-vinyl acetates and vinyl chloride copolymers, polyamides, cellulose derivatives and copolymers of these, and mixtures of two or more of these polymers.

Polymers particularly preferred are polyamides, such as nylon-4,6, nylon-6, nylon-11, nylon-6,6, nylon-6/6, nylon-6/10, or nylon-6/12, polypropylene, polyethylene, styrene-acrylonitrile copolymers, acrylonitrile-butadiene-styrene, acrylonitrile-styrene-acrylate, polyoxymethylene, polysulfones, polyether sulfones, polyphenylene sulfones, polybutylene terephthalate, polycarbonates, and mixtures of these.

The polymer material is preferably a reinforced material. In particular, the polymer material is fiber-reinforced. Any known fibers conventionally used for reinforcement and known to the person skilled in the art can be used for this reinforcement. Examples of suitable fibers are glass fibers, carbon fibers, aramid fibers, basalt fibers, boron fibers, metal fibers, and potassium titanate fibers. The fibers can be used in the form of short fibers or of long fibers. The fibers can also be present in ordered or unordered form in the polymer material. In particular when long fibers are used, however, an ordered arrangement is usual. The fibers here can by way of example be used in the form of individual fibers, fiber strands, mats, wovens, knits, or rovings. If the fibers are used in the form of long fibers, or as rovings or as fiber mat, the fibers are usually placed in a mold, the polymer material then being poured around them. The resultant structure can have one or more layers. In the case of a structure having more than one layer, the fibers of each of the individual layers can have the same orientation, or the fibers of the individual layers can be at an angle of from −90° to +90° to one another.

However, it is preferable to use short fibers. When short fibers are used, these are usually admixed with the polymer composition prior to hardening. The main body of the structure can by way of example be manufactured via extrusion, injection molding, or casting. It is preferable that the main body of the structure is manufactured by injection molding or casting. The short fibers are generally in unoriented form in the structure.

However, if the structure is produced via an injection-molding process, orientation of the short fibers can result when the polymer composition comprising the fibers is forced through an injection nozzle into the mold.

Suitable reinforcing agents are not only fibers but also any desired other fillers which are known to the person skilled in the art and which act to increase stiffness and/or to increase strength. Among these are inter alia any desired particles with no preferential orientation. Particles of this type are generally spherical, lamellar, or cylindrical. The actual shape of the particles here can deviate from the idealized shape. In particular, therefore, spherical particles can actually by way of example also have a droplet shape or a flattened shape.

Examples of reinforcing materials used, besides fibers, are graphite, chalk, talc and nanoscale fillers.

However, it is particularly preferable to use glass fibers for reinforcement. Glassfiber-reinforced polyamides are particularly preferred as material for production of the structure for absorbing energy.

Production of the structure for absorbing energy can use not only polymer materials but also metals, which can be shaped via casting processes. Suitable materials are therefore by way of example low-density metals that are processable via diecasting processes, examples being aluminum and magnesium. However, it is also possible to use ferrous metals, such as steel or cast iron, where these can be processed via casting processes. Another possible method produces corresponding energy-absorbing components from metallic materials via a process of punching and bending.

In one embodiment of the invention, a foamed core is introduced into a space defined via the internal areas of the profile elements which are open on one side. Introduction of the foamed core moreover permits appropriate modification of the force-displacement characteristic of the energy-absorbing component. Another effect of use of a foam is that, given stable connection of foam and polymer material of the profile elements, there is no possibility that individual splinters will break away during failure of the component and cause injuries. In order to obtain stable connection of profile element and foam, it is possible to use a foam made of a thermoplastic polymer, where by way of example the foam is welded to the profile element. However, it is preferable to connect the foam by way of example via adhesion to the profile elements. In another alternative possibility, the foam is not connected by friction or interlock bonding to the profiles but instead is positioned in the internal space formed by the profile elements. Stable fixing of the foam can by way of example be achieved when the foam is produced within the internal space and, during the foaming process, concomitantly encloses the profile elements or, respectively, is forced against the profile elements.

Examples of suitable materials for the foam, if this type of foam core is used, are thermoplastic or thermoset, open-cell or closed-cell foams. It is possible here to use any desired foamable plastic to produce an appropriate foam. Preferred materials for the foam core are those known as energy-absorbing foams made of polyethylene or polyurethane.

Appropriate modification of the profile elements to the desired force-displacement characteristic is possible by way of example by reinforcing the individual profile elements at one side with ribs. It is particularly preferable here to reinforce the profile elements with ribs at their internal sides, i.e. at the sides which face toward the opposite profile elements. The number and geometry of the ribs here is appropriately modified to give the desired force-displacement characteristic. On the one hand, it is possible here that all of the profile elements that have been connected to give the energy-absorbing component are provided with an equal number of ribs, or else have different numbers of ribs. It is also possible that all of the ribs have the same geometry. In an alternative possibility, the ribs of the individual profile elements have respectively different geometries.

If the individual profile elements are equipped with ribs, the ribs are preferably formed concomitantly in the manner of a single piece during the injection molding of the energy-absorbing component. However, it is also possible, as alternative, by way of example, to produce separate ribs and then to connect these, for example, by a welding process to the profile elements. However, it is preferable to form the ribs in the manner of a single part during the production of the energy-absorbing component.

Another alternative possibility, alongside the use of ribs, is to modify the component appropriately to give an ideal force-displacement curve via individual design of the individual profile elements. By way of example, the wall thickness and the width of the individual profile elements, and also the number of ribs, can be appropriately modified to give the ideal force-displacement curve. An increase in the wall thickness leads, for example, to less deformation than would be the case for a thinner wall on application of the same force. Reduction of the wall thickness can correspondingly be used to increase the extent of deformation on application of the same force.

By virtue of the connection at one side in the manner of a single part, the individual profile elements respectively transmit force to the adjacent profile elements, and it is therefore also possible to achieve appropriate modification of the force-displacement characteristic via the width of the individual profile element.

The energy-absorbing component is particularly suitable for use in a bumper in a motor vehicle. The energy-absorbing component which is produced via the process of the invention can moreover also by way of example be used as general absorber for lateral impact, rear impact, or head impact. Possible installation locations in a motor vehicle are found under the hood, in the region of the side skirt, in the door module, or in the interior under cladding elements. It is possible to use the energy-absorbing components not only in a motor vehicle but also in packaging technology, for protection of goods requiring packaging.

The figures depict embodiments of the invention, which are explained in more detail in the description below.

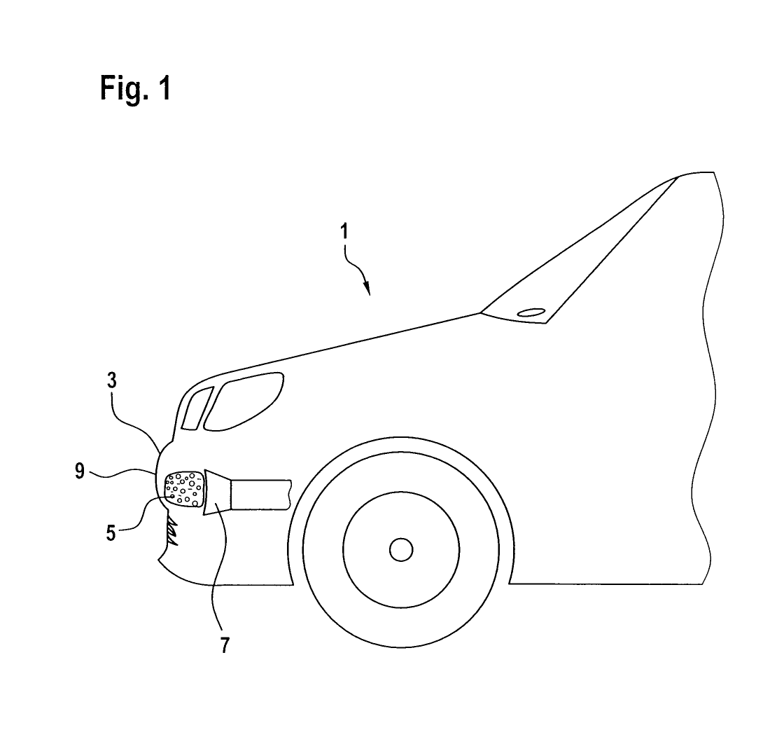

FIG. 1 is a diagram of a motor vehicle depicting the installation location of a frontal absorber structure.

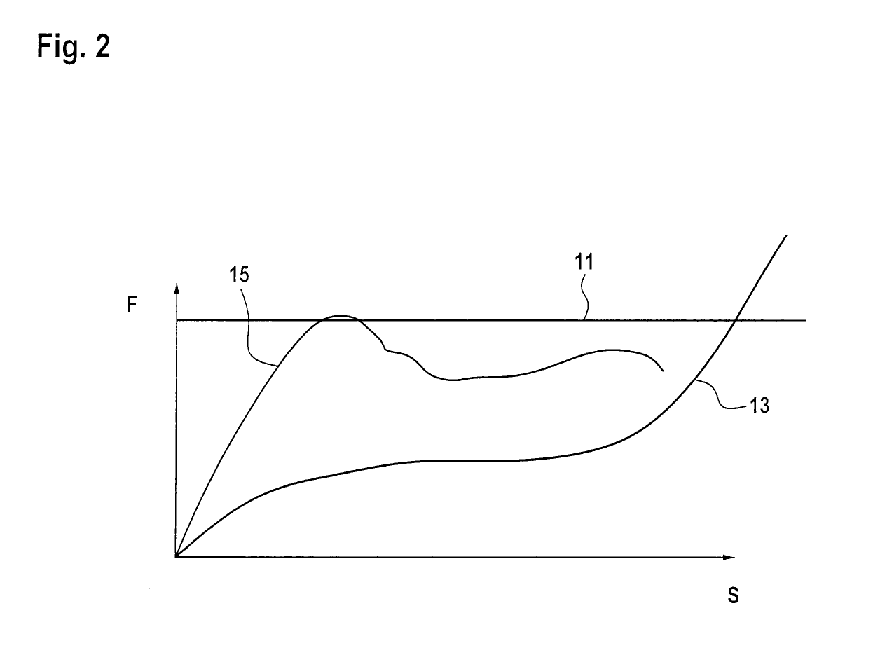

FIG. 2 shows force-displacement curves for various absorber structures.

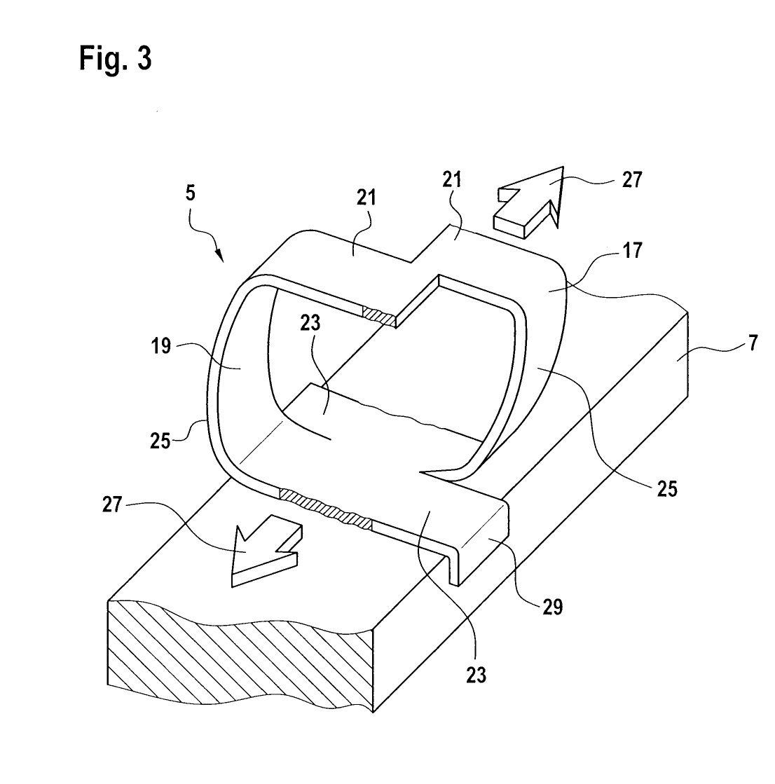

FIG. 3 is a three-dimensional depiction of an energy-absorbing component designed in the invention.

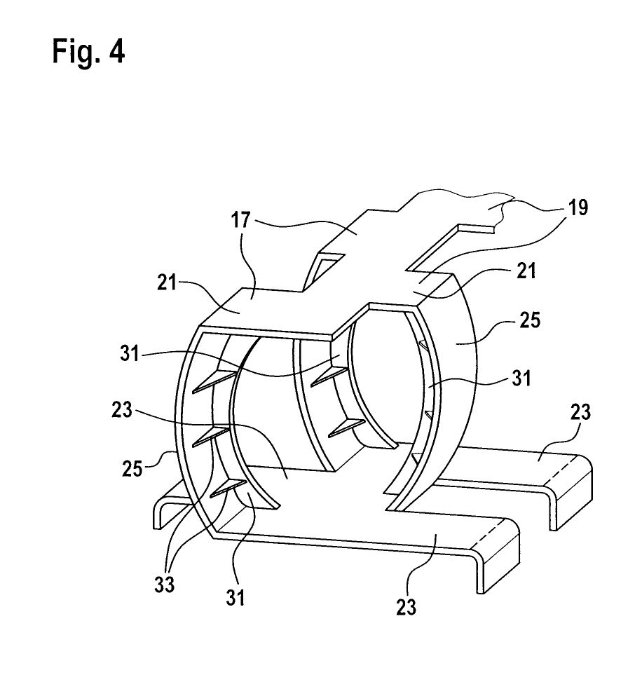

FIG. 4 is a three-dimensional depiction of a second embodiment of an energy-absorbing component.

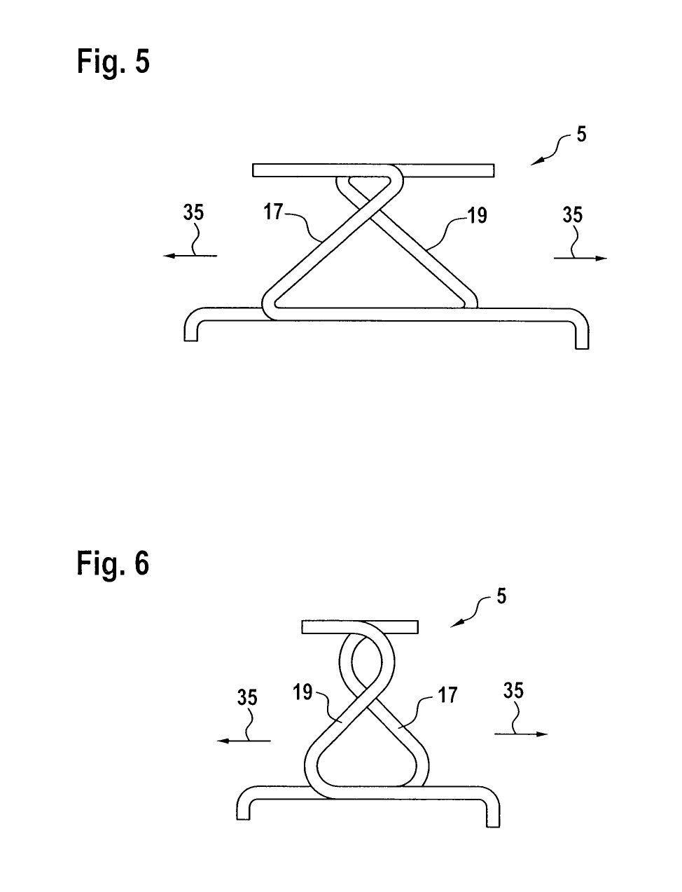

FIG. 5 is a side view of an energy-absorbing component of the invention with z-shaped profile elements.

FIG. 6 is a side view of an energy-absorbing component of the invention with s-shaped profile elements.

FIG. 1 is a diagram of a frontal portion of a motor vehicle with installation location of an absorber structure.

A motor vehicle 1 usually comprises a frontal bumper 3 and a rear bumper, not depicted here. The structure of the frontal bumper and of the rear bumper is in essence identical.

The frontal bumper comprises an energy-absorbing component 5, connected to a cross-member 7 of the motor vehicle. In front of the energy-absorbing component 5 there is an exterior protective cover 9. There is usually a gap between the exterior protective cover 9, which also forms the exterior shape of the motor vehicle, and the energy-absorbing component 5. On collision with an inanimate object, such as another vehicle, or else with an animate object, such as a person, the exterior protective cover 9 first deforms and thus absorbs energy. The deformation of the exterior protective cover 9 varies with the strength of the impact and can be sufficiently great to bring it into contact with the energy-absorbing component 5, thus causing deformation of the energy-absorbing component 5 due to the effect of the applied force. The deformation process of the energy-absorbing component 5 consumes energy. In the event of a collision and application of a force, the deformation of the energy-absorbing component 5 absorbs some of the force acting on the object colliding with the vehicle, and the damage to the object is therefore less than that for impact on a rigid element.

The prior art usually uses an element made of a foam material, for example a polymer foam, as energy-absorbing component 5. Energy-absorbing components made of unfoamed plastic are another alternative currently used, where these have been designed in such a way that the plastic initially deforms on encountering a force, and then fails via fracture. The energy-absorbing component 5 absorbs energy by virtue of the deformation and the fracture.

FIG. 2 depicts the force-displacement characteristics for various materials.

The extent of deformation is shown on the x axis, and the force F is shown on the y axis.

An ideal energy-absorbing system which comprises the energy-absorbing component exhibits a constant characteristic for F, where the extent of deformation should remain constant if the force acting on the component is constant. This means that, irrespective of the deformation that has previously taken place, deformation continuous to increase linearly when a constant force is applied.

A force-displacement curve for an energy-absorbing foam as currently used is depicted at reference symbol 13. It can be seen here that on application of a comparatively small force a large deformation initially takes place, and as deformation increases there has to be an increase in the force required for further deformation of, i.e. compression of, the foam. As a result of this type of behavior exhibited by an energy-absorbing foam, contrasting with the ideal energy-absorbing component, the total amount of energy that can be absorbed by the foam is less than for a component which follows the ideal force-displacement curve 11.

A possible force-displacement curve for a component of the invention has been depicted, using the curve indicated by reference symbol 15. The force-displacement curve for an energy-absorbing component of the present invention differs from the force-displacement curve for an energy-absorbing foam in that it approximates to the ideal curve. The energy-absorbing component of the invention can be designed in such a way that it can initially, in the course of a small displacement, absorb a larger force than an energy-absorbing foam, and then, by virtue of controlled deformation and failure, can achieve a curve which is closer than the force-displacement curve 13 of an energy-absorbing foam to the ideal force-displacement curve 11.

FIG. 3 shows a detail of a first embodiment of a component of the invention.

An energy-absorbing component 5 designed in the invention is composed of individual profile elements 17, 19. The profile elements 17, 19 are, in the invention, respectively open on one side and oriented in an opposite direction.

The individual profile elements 17, 19 here can by way of example be u-shaped as depicted in FIG. 3. The individual profile elements 17, 19 here respectively have a first leg 21, a second leg 23, and a basal section 25. The basal section 25 here can by way of example have convex curvature, as depicted here. Another alternative, however, is that the basal section 25 has concave curvature or has any desired other structure, for example a corrugated shape or a zig-zag shape.

The individual opposite profile elements 17, 19, open on one side, have been connected to one another in the invention at their respective first legs 21 to give a strip. If these are u-shaped, as depicted in FIG. 3, the respective second legs 23 have also been connected with one another to give a strip.

If the energy-absorbing component 5 is used in a motor vehicle, the second legs 23 have been used to connect it to the cross-member 7 of the vehicle bodywork. The orientation of the energy-absorbing component 5 in the vehicle is such that a force acting on the energy-absorbing component 5 acts on the first legs 21. The action of the force on the first legs 21 initially causes deformation of the energy-absorbing component 5 in the region of the basal section 25. During this process, the first legs 21 are forced in the direction of the second legs 23. Once the deformation limit has been reached, the basal section 25 gives way and the energy-absorbing component 5 fails through fracture. Another possibility, depending on the material used, is that no failure of the component occurs, but instead deformation occurs until the first legs 21 are in contact with the second legs 23.

Arrows 27 in FIG. 3 depict continuation, in the direction of the arrows, of the respective profile elements 17, 19, open on one side, with the resulting possibility of producing an energy-absorbing component 5 of any desired width.

Stable connection to the cross-member 7 is achieved by the presence, on the respective second legs 23, of a flange 29 with which the legs enclose the cross-member 7.

The individual profile elements 17, 19 can be designed individually, varying with the desired failure behavior. By way of example, all of the profile elements can have an identical shape, as depicted in FIG. 3, but in a possible alternative the profile elements can respectively have been designed with different width or else can have a different basal section.

If the energy-absorbing component 5 is designed in the invention, it is possible to produce the same via an injection-molding process in one operation. To this end, the design of the respective mold sections is such that these respectively have projections which correspond to the internal outline of the profile elements, open on one side, and, adjacent to the respective projections, there are recessed sections which correspond to the external outline of the adjacent profile element. The mold sections are arranged oppositely and moved toward one another in order to close the mold. During this process, the respective projections intermesh. The plastics material can then be injected. For removal of the material, the mold sections are in turn moved apart, and the finished component can be removed.

In order to achieve further influence on the force-displacement characteristic of the energy-absorbing component 5, it is also possible to introduce a core made of a polymer foam into the cavity formed by the respective opposite profile elements 17, 19, open on one side. By way of example, this can be inserted after the manufacture of the energy-absorbing component 5. In another alternative possibility, the energy-absorbing component 5 is placed in a mold and an expandable polymer is injected, which then expands and foams in the mold. The advantage of said process is that the foaming in the mold can produce a stable connection to the energy-absorbing component 5.

FIG. 4 depicts an alternative design of an energy-absorbing component 5.

The embodiment depicted in FIG. 4 differs from the embodiment depicted in FIG. 3 in that the basal section 25 of the individual profile elements 17, 19 has been reinforced respectively via a fillet 31 and by ribs 33 connected to the fillet 31 and to the basal section 25. The design of the fillet 31 and of the ribs 33 here is such that these do not inhibit removal of the mold section and are not damaged during removal of the mold section. To this end, the fillets 31 and the ribs 33 have preferably been designed so that, in the direction of opening of the mold section, they have parallel surfaces or have a decreasing separation distance of the respective opposite surfaces. By using this method, the fillets 31 and ribs 33 can likewise be formed in one operation. In an alternative possibility, the fillets 31 and/or ribs 33 can also be introduced subsequently. However, production in one operation is preferred.

As an alternative to the design depicted in FIGS. 3 and 4 with profile elements 17, 19 which are in essence u-shaped, it is also possible to design the profile elements 17, 19 so that they are, for example, s-shaped or z-shaped. FIGS. 5 and 6 depict the corresponding design by way of example. The direction of opening of the mold section here has been respectively depicted by arrows 35. FIG. 5 here depicts a z-shaped profile, and FIG. 6 here depicts an s-shaped profile.

A possible method for appropriate modification to give the desired force-displacement characteristic, is also to vary the shape of the individual profile elements, alongside the width of the individual profile elements. By way of example, therefore, it is also possible to combine profile elements of different geometries in an energy-absorbing component 5, examples being u-shaped, s-shaped, and z-shaped profile elements, in any desired arrangement with one another. Another possibility is to use fillets and ribs to reinforce only a portion of the profile elements, or to reinforce all of the profile elements.

By changing the parameters, for example the width and shape of the profile elements, it is possible to adjust the force-displacement curve in controlled fashion across the entire width of the component, and it is possible here that different force-displacement curves may be desirable in different regions of the component.

### KEY

1 Motor vehicle
3 Bumper
5 Energy-absorbing component
7 Cross-member
9 Exterior protective covering
11 Force-displacement curve
13 Force-displacement curve for an energy-absorbing foam
15 Force-displacement curve for a component of the invention
17 Profile element
19 Profile element
21 First leg
23 Second leg
25 Basal section
27 Prolongation
29 Flange
31 Fillet
33 Ribs

1. A process for producing an energy-absorbing component (5) composed of profile elements (17, 19) made of a polymer material which are open on one side and have been respectively orientated in opposite direction, and have been connected to one another at at least one side in the manner of a single piece to give a linearly continuous structure, comprising the following steps:
(a) closure of a mold comprising at least two mold-section profiles which can be moved in an opposite direction and respectively have, in alternating fashion, protruding regions in the form of negative image of the internal side of a profile element (17, 19), and recessed regions in the form of negative image of the external side of an adjacent profile element (19, 17), where, in the closed condition, the protruding regions of the oppositely arranged mold-section profiles intermesh,
(b) injection of the polymer material into a mold,
(c) opening of the mold, by moving the mold-section profiles apart in an opposite direction, and removal of the component.

2. The process according to claim 1, wherein the polymer material is a thermoplastic polymer or an injection-moldable thermoset polymer.

3. The process according to claim 2, wherein polymer material has been reinforced.

4. The process according to claim 3, wherein the polymer material comprises short fibers for reinforcement.

5. The process according to claim 4, wherein the short fibers are glass fibers, carbon fibers, aramid fibers, boron fibers, metal fibers, or potassium titanate fibers.

6. The process according to claim 1, wherein a foamed core is introduced into a space defined via the internal areas of the profile elements which are open on one side.

7. The process according to claim 1, wherein the profile elements (17, 19) have respectively been reinforced with ribs (33) at their internal side.

8. The process according to claim 1, wherein the component is appropriately modified to give an ideal force-displacement curve via individual design of the individual profile elements (17, 19).

9. The process according to claim 8, wherein the wall thickness and the width of the profile elements (17, 19), and also the number of ribs, can be appropriately modified to give the ideal force-displacement curve.

10. The process according to claim 1, wherein the component (5) is a force-absorbing component (5) in a bumper (5) for a motor vehicle (1).

11. An energy-absorbing component comprising profile elements (17, 19) which are open on one side and have been respectively orientated in opposite direction, and have been connected to one another at at least one side in the manner of a single piece to give a linearly continuous structure.

12. The energy-absorbing component according to claim 11, wherein the profile elements are s-shaped, z-shaped, or u-shaped.

13. The energy-absorbing component according to claim 10, which is composed of profile elements with different geometry.
